(19) United States
(12) Patent Application Publication
(10) Pub. No.: US 2019/0101791 A1
(43) Pub. Date: Apr. 4, 2019

(54) OPTICAL SENSING DEVICE AND STRUCTURED LIGHT PROJECTOR

(71) Applicant: LIQXTAL TECHNOLOGY INC., Tainan City (TW)

(72) Inventors: Hung-Shan Chen, Tainan City (TW); Yen-Chen Chen, Tainan City (TW)

(73) Assignee: LIQXTAL TECHNOLOGY INC., Tainan City (TW)

(21) Appl. No.: 16/044,484

(22) Filed: Jul. 24, 2018

Related U.S. Application Data
(60) Provisional application No. 62/566,538, filed on Oct. 2, 2017.

(51) Int. Cl. G02F 1/1335; G02F 1/1337; G02F 1/1343; G02B 27/09

(52) U.S. Cl. CPC G02F 1/133526; G02F 1/1337; G02B 27/0955; G02F 1/1343; G02F 1/133528

(57) ABSTRACT

An optical sensing device is provided. The optical sensing device includes a structured light projector and a sensor. The structured light projector is configured to project a structured light to the object. The structured light projector includes a light source, a diffractive optical element, and a liquid crystal lens module. The light source is configured to emit a light beam. The diffractive optical element is disposed on a path of the light beam and configured to generate diffraction patterns so as to form the structured light. The liquid crystal lens module is disposed on at least one of the path of the light beam and a path of the structured light and capable of controlling between at least two focusing state. The sensor is disposed adjacent to the structured light projector and configured to sense a reflected structured light from the object. Besides, a structured light projector is also provided.

### CROSS-REFERENCE TO RELATED APPLICATION

This application claims the priority benefit of U.S. provisional application Ser. No. 62/566,538, filed on Oct. 2, 2017. The entirety of the above-mentioned patent application is hereby incorporated by reference herein and made a part of this specification.

### BACKGROUND

### Technical Field

The invention generally relates to a sensing device and a light projector, and, in particular, to an optical sensing device and a structured light projector.

### Description of Related Art

At present, the mainstream technology in the field of 3-dimension (3D) sensing is divided into time of flight (TOF) and structured illumination. The TOF technology uses pulsed laser and complementary metal-oxide-semiconductor (CMOS) sensor to calculate the distance based on a measured reflection time. Due to the structure and costs, TOF 3D sensing is generally more suitable for resolving objects at long distance. In structured illumination, infrared source projects IR light onto a diffractive optical element to produce 2D diffraction patterns, while a sensor is used to collect the reflected light. The distance of an object in 3-dimension can then be calculated using triangulation method. Structured illumination is limited by having projection lens with fixed focal length, which limits the distance that a clear and focused diffraction pattern are able to form, ultimately limiting the distance of an object that is resolvable to be within a small range.

To solve the foregoing problem of structured illumination, adding apodized lens to the lens group in order to produce a multifocal system was proposed. However, such a method comes at the expense of light efficiency, 2D diffraction pattern points and resolution.

### SUMMARY

The invention provides an optical sensing device which uses liquid crystal to control the focus of a structured light.

The invention provides a structured light projector which uses liquid crystal to control the focus of a structured light.

According to an embodiment of the invention, an optical sensing device adapted to detect an object or features of the object is provided. The optical sensing device includes a structured light projector and a sensor. The structured light projector is configured to project a structured light to the object. The structured light projector includes a light source, a diffractive optical element, and a liquid crystal lens module. The light source is configured to emit a light beam. The diffractive optical element is disposed on a path of the light beam and configured to generate diffraction patterns so as to form the structured light. The liquid crystal lens module is disposed on at least one of the path of the light beam and a path of the structured light and capable of controlling between at least two focusing state. The sensor is disposed adjacent to the structured light projector and configured to sense a reflected light. The reflected light is reflection of the structured light from the object.

According to an embodiment of the invention, a structured light projector is provided. The structured light projector includes a light source, a diffractive optical element, and a liquid crystal lens module. The light source is configured to emit a light beam. The diffractive optical element is disposed on a path of the light beam and configured to generate diffraction patterns so as to form the structured light. The liquid crystal lens module is disposed on at least one of the path of the light beam and a path of the structured light and capable of controlling between at least two focusing state.

Base on the above, the structured light projector according to some embodiments includes at least one liquid crystal lens module with variable focal length. Having the liquid crystal lens module with variable focal length in the structured light projector increase the range of projected structured being in focus. Furthermore, a small optical sensor using the above structured light projector may be obtained.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic diagram of an optical sensing device according to an embodiment of the invention.

FIG. 2 is a schematic cross-sectional view of a structured light projector of FIG. 1.

FIGS. 3A-3C are schematic cross-sectional views of another structured light projector according to at least one embodiment of the invention.

FIGS. 4A-4B are schematic cross-sectional views of various liquid crystal lens modules of FIG. 2 under two different states according to at least one embodiment of the invention.

FIGS. 5-8 are schematic cross-sectional views of various liquid crystal lens modules of FIG. 2 according to at least one embodiment of the invention.

FIG. 9 is a schematic diagram of a liquid crystal layer from a top view, in accordance with at least one embodiment of the invention.

FIGS. 10A-10B are schematic cross-sectional diagrams of another liquid crystal lens modules under two different states according to at least one embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Further, spatially relative terms, such as “underlying”, “below”, “lower”, “overlying”, “upper”, “top”, “bottom”, “left”, “right” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

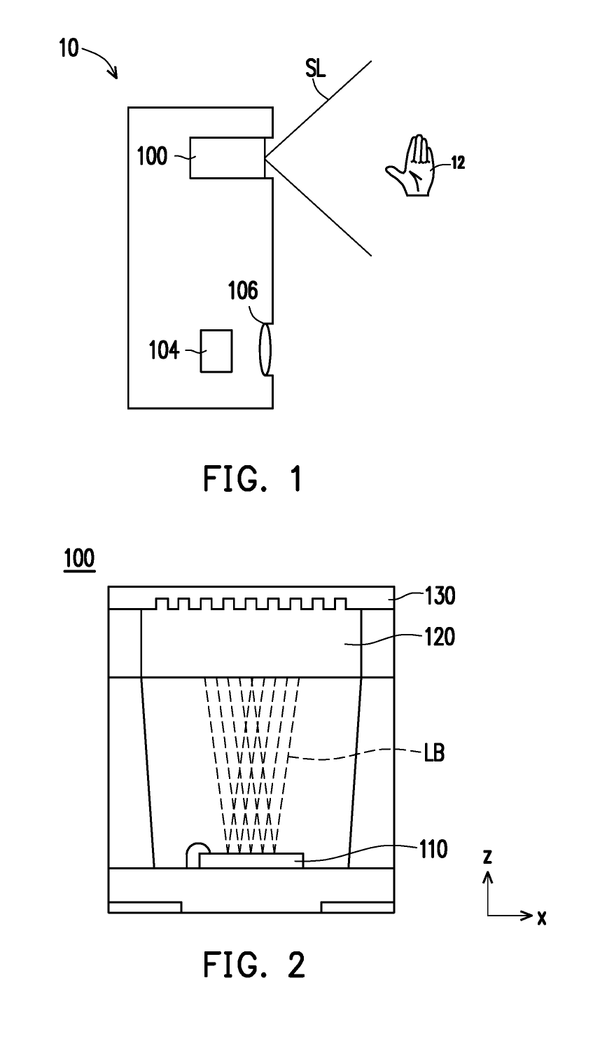

FIG. 1 is a schematic cross-sectional view of an optical sensing device 10 according to an embodiment of the invention. The optical sensing device 10 shown in FIG. 1 is a sensing device which uses structured light to detect an object. More specifically, the optical sensing device 10 includes a structured light projector 100 and a sensor 104 disposed adjacent to the structured light projector 100. The structured light projector 100 is configured to generate a structured light SL towards an object 102, and a sensor 104 is configured to sense the structured light SL reflected from the object 102. The structured light may include, but are not limited to, multiple light beams that project a light pattern such as a series of lines, circles, dots or the like, to an object 102, wherein the lines, circles, dots or the like may or may not be arranged in an ordered manner. The object 102 may be, for example, a hand, a human face or any other objects that have 3D features. When the structured light SL is projected on the object 102, the light pattern of the structured light SL may deform due to the concave-convex surface of the object 102. The deformed structured light SL is then reflected from object 102, the reflected light passes through an opening 106 before reaching sensor 104. The opening 106 includes, for example, a lens, an aperture, a transparent cover or the like. The sensor 104 senses the deformation of the light pattern on the object 102 so as to calculate the depths of the surface of the object 12, i.e. distances from points on the object 102 to the sensors 104. Sensor 104 may be connected to a processor (not shown) to calculate the 3-dimensional feature of the object 102.

FIG. 2 is a cross-sectional diagram of a structured light projector 100 according to an embodiment of the invention. The structured light projector 100 shown includes a light source 110, a liquid crystal lens module 120 and a diffractive optical element 130. The light source 110 disposed on one end of the structured light projector 100 is configured to emit a light beam LB. The light source 110 may be a light emitting device (LED), laser diode, an edge emitting laser, a vertical-cavity surface-emitting laser (VCSEL) or any other suitable light source capable of emitting a visible or non-visible (e.g. infrared (IR) or ultraviolet (UV)) light beam LB. In some embodiments, the light source 110 may be a single IR laser diode, in some other embodiments the light source 110 may be an array of IR laser diode, the number of light source forming light source 110 is not limited.

The structured light projector 100 further includes a liquid crystal lens module 120 disposed on the path of light beam LB. The liquid crystal lens module 120 is capable of controlling the focusing states of the light beam LB and provide at least two focusing state to the structured light projector 100. Optionally, a polarizer (not shown) may be placed on the path of the light beam LB before the liquid crystal lens module 120 to provide liquid crystal lens module 120 with a polarized (e.g. linear polarized or circular polarized) light beam LB.

In FIG. 2, the diffractive optical element 130 is shown to be disposed on the path of the light beam LB after liquid crystal lens module 120, however the order of placement of diffractive optical element 130 and liquid crystal lens module 120 is not limited. In some embodiments, the diffractive optical element 130 may be disposed on the path of the light beam LB before liquid crystal lens module 120. In some embodiments, the diffractive optical element 130 may even be disposed between elements of liquid crystal lens module 120 on the path of the light beam LB. The diffractive optical element 130 is an optical element configured to generate diffraction patterns in order to generate the structured light SL as described above with reference to FIG. 1. For example, the diffractive optical element 130 may contain patterns that splits the light beam LB into multiple dots, or shape the light beam into gridlines, but is not limited thereto. For simplicity, the light beam LB after passing diffractive optical element 130 will henceforth be referred to as structured light SL. Furthermore, for ease of description, mutually orthogonal x-direction and z-direction is provided. For example, in the present embodiment, the z-direction is defined as the direction perpendicular to the light emitting surface of the light source 110.

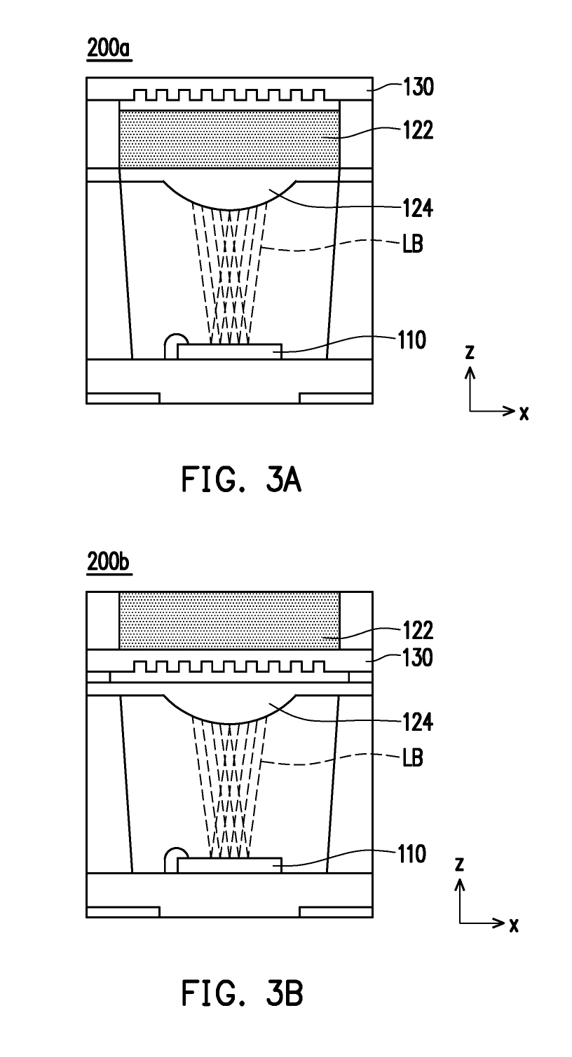

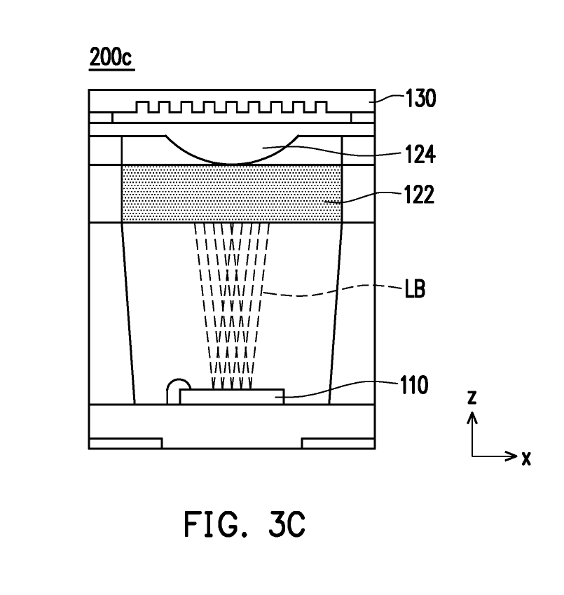

FIG. 3A-3C show schematic cross-sectional views of variations of structured light projectors 200a-200c according to some embodiments of the invention. Structured light projectors 200a-200c are similar to structured light projector 100 shown in FIG. 2. The difference between structured light projectors 200a-200c and structured light projector 100 lies in that structured light projectors 200a-200c include a liquid crystal lens cell 122 and a solid lens 124 while omitting liquid crystal lens module 120. In some embodiment, the combination of liquid crystal lens cell 122 and solid lens 124 may also be regarded as liquid crystal lens module 120 of FIG. 2.

Referring to FIG. 3A, the solid lens 124 is disposed on the path of the light beam LB between the diffractive optical element 130 and the light source 110, and the liquid crystal lens cell 122 is disposed on the path of the light beam LB between solid lens 124 and diffractive optical element 130. In FIG. 3B, the solid lens 124 is disposed on the path of the light beam LB between the diffractive optical element 130 and the light source 110, and the liquid crystal lens cell 122 is disposed on the side of diffractive optical element 130 away from the light source. In other words, liquid crystal lens cell 122 is disposed on the path of the structured light SL. In FIG. 3C, the solid lens 124 is disposed on the path of the light beam LB between the diffractive optical element 130 and the light source 110, and the liquid crystal lens cell 122 is disposed on the path of the light beam LB between solid lens 124 and light source 110.

In some embodiments, solid lens 124 may be a single lens or a multiple lens group that determines the primary focal length of the structured light projector 200a. In some embodiments, solid lens 124 collimates the light beam LB before light beam LB enters liquid crystal lens cell 122 or diffractive optical element. In some embodiments, the liquid crystal lens cell 122 has a variable focal length and includes least one liquid crystal cell layer. The focal length of the liquid crystal lens cell 122 is controlled by controlling the orientation of the liquid crystal molecules (not shown) in the liquid crystal lens cell 122 by application of external electric field.

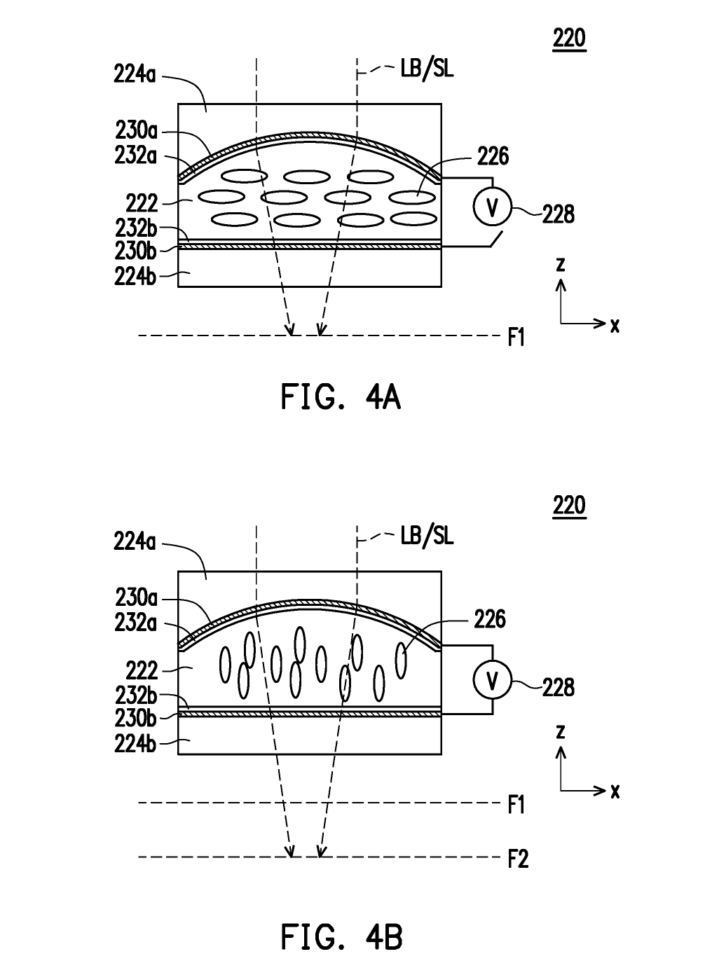

FIG. 4A-8 disclose some embodiment of liquid crystal lens module which may be used as liquid crystal lens module 120 of FIG. 2. In some embodiments, liquid crystal lens module disclosed in FIG. 4A-8 may be used as liquid crystal lens cell 122 of FIG. 3A-3C and the invention is not limited thereto.

FIGS. 4A and 4B are schematic cross-sectional views of liquid crystal lens module 220 according to an embodiment of the invention. The liquid crystal lens module 220 includes a first substrate 224a, a second substrate 224b, and a liquid crystal layer 222. The liquid crystal layer 222 is sandwiched between the first substrate 224a and the second substrate 224b in the vertical z-direction. An effective refractive index of each position on the liquid crystal layer 222 is related to a voltage applied on a first electrode 230a and a second electrode 230b, wherein the first electrode 230a is disposed on the first substrate between the liquid crystal layer 222 and first substrate 224a, the second electrode 230b is disposed on second substrate 224b between the liquid crystal layer 222 and second substrate 224b, and the voltage is provided by power source 228. The liquid crystal lens module 220 further includes alignment layers 232 disposed on first electrode 230a and second electrode 230b respectively and in contact with two opposing sides of liquid crystal layer 222. The alignment layers 232a and 232b are layers having a surface texture to align the liquid crystal molecules 226 to an initial direction by controlling the pretilt angle and the polar angle of the liquid crystal molecules 226. The pretilt angle is an angle between the long axis of a liquid crystal molecule 226 and a plane perpendicular to the z-direction, the polar angle is an angle between the long axis of a liquid crystal 226 and a fixed axis (e.g. along x-direction) in the plane perpendicular to z-direction. The materials for alignment layer 232 used in the present embodiments may be a polymer such as polyimide, but is not limited thereto.

Referring to FIG. 4A, the liquid crystal layer 222 of liquid crystal lens module 220 is a layer with non-unifonr thickness. As shown in FIG. 4A, liquid crystal layer 222 has curved surface and a flat surface, and is thickest in the middle part. The curved surface of the liquid crystal layer 222 corresponds to a curved surface of first substrate 224a, curved first electrode 230a and a curved top alignment layer 232. Furthermore, in the present embodiment, when disconnected from power source 228, liquid crystal molecules 226 are aligned to be substantially in the same orientation throughout liquid crystal layer 222, i.e. all the long axis of liquid crystal molecules 226 are along the horizontal x-direction, wherein the x-direction and z-direction are orthogonal. When the electrodes 230a and 230b are connected to power source 228, as shown in FIG. 4B, the orientation of liquid crystal molecules 226 is rotated such that the long axis is aligned to the z-direction.

In the present embodiment, liquid crystal lens module 220 of FIG. 4A-4B can be regarded as a refractive lens. Specifically, when liquid crystal lens module 220 is not connected to power source 228, the liquid crystal layer 222 has a first effective refractive index such that when combined with the convex shape of the liquid crystal lens module 220, light entering along the z-direction will be focused to a first focal length F1. In FIG. 4B, when liquid crystal layer 222 is connected to power source 228, the alignment of liquid crystal molecules 226 along the z-direction change the effective refractive index of the liquid crystal layer 222 to a second effective refractive index such that when combined with the convex shape of the liquid crystal layer 222, light entering along the z-direction will be focused to a second focal length F2. Therefore, the focal length of liquid crystal lens module 220 can be controlled by switching the power source 228 on or off.

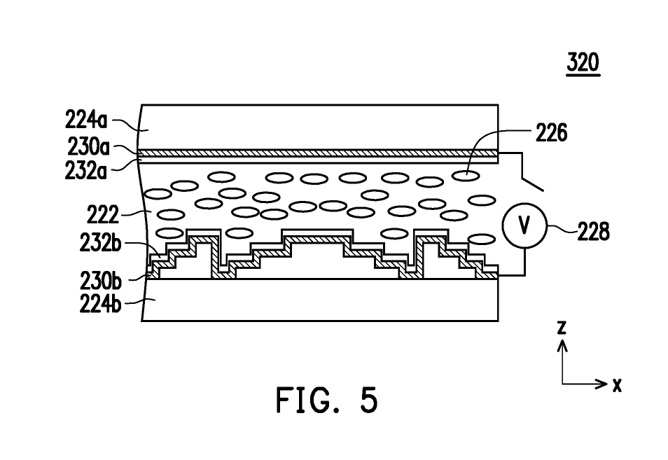

FIG. 5 is a schematic cross-sectional view of liquid crystal lens module 320 according to an embodiment of the invention. The liquid crystal lens module 320 includes first substrate 224a, second substrate 224b, liquid crystal layer 222, first electrode 230a, second electrode 230b and alignment layers 232a and 232b that are arranged similarly to liquid crystal lens module 220. Referring to FIG. 5, the difference between liquid crystal lens module 320 and liquid crystal lens module 220 lies in the first substrate 224a, the first and second electrodes 230a and 230b, and the shape of first alignment layers 232a. Specifically, in FIG. 5, the first substrate 224a is a substrate having uniform thickness in z-direction, the first electrode 230a and top alignment layer 232 is planar, and the second electrode 230b and second alignment layers 232b are stepped. Due second electrode 230b and second alignment layers 332 being stepped, the liquid crystal layer 222 is liquid crystal layer having non-uniform thickness that has optical properties of a diffractive lens. The stepped second electrode 230b and second alignment layer 232b may be designed, for example, in a way that the liquid crystal layer 222 following the shape of the steps may be a Fresnel lens, but the invention is not limited thereto. Similar to liquid crystal lens module 220, the focal length of liquid crystal lens module 320 may be controlled by applying a voltage across first electrodes 230a and second electrodes 230b.

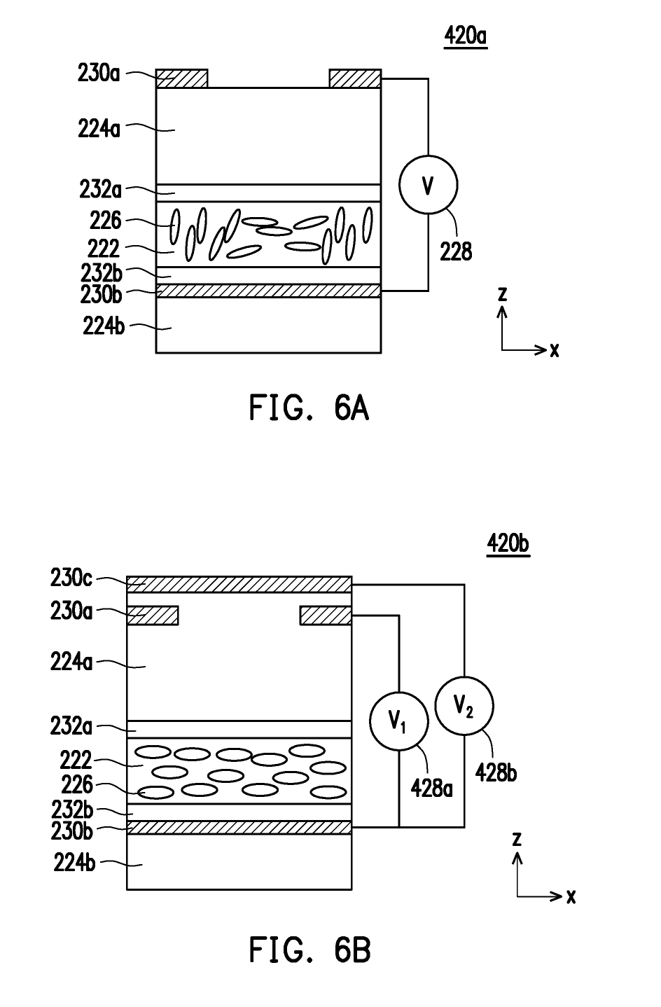

FIG. 6A is a schematic cross-sectional view of liquid crystal lens module 420a according to an embodiment of the invention.

In FIG. 6A, the liquid crystal lens module 420a includes first substrate 224a, second substrate 224b, liquid crystal layer 222, second electrode 230b and alignment layers 232a and 232b that are arranged similarly to liquid crystal lens module 220. Referring to FIG. FIG. 6A, the difference between liquid crystal lens module 420a and liquid crystal lens module 220 lies in the first substrate 224a, the first electrode 230a, and the first alignment layers 232a. Specifically, in FIG. 6A, the first substrate 224a is a substrate having uniform thickness in z-direction, the first electrode 230a is a patterned electrode having a gap or opening in between and disposed on a side of the first substrate 224a opposite the liquid crystal layer 222, and the first alignment layers 232a is planar. Accordingly, the liquid crystal layer 222 of the present embodiment has uniform thickness. In some embodiments, the first electrode 230a may also be disposed between the first substrate 224a and the first alignment layers 232a, but is not limited thereto.

Due to the pattern of the first electrode 230a, voltage in the liquid crystal layer 222 is unevenly distributed, resulting in liquid crystal molecules having varying orientation when first electrode 230a is connected to a power source. In some embodiments, the pattern of the first electrode 230a may be any other pattern other than the pattern shown in FIG. 6A. The uneven distribution of liquid crystal orientation produces a distributed refractive index. Depending on the distribution of the refractive index, the liquid crystal lens module 420a may be a refractive lens or a diffractive lens.

FIG. 6B is a schematic cross-sectional view of liquid crystal lens module 420b according to an embodiment of the invention. Liquid crystal lens module 420b is similar to liquid crystal lens module 420a except that liquid crystal lens module 420b further includes a third electrode 230c disposed adjacent to the first electrode 230a away from the liquid crystal layer 222. In this embodiment, the first and second electrode 230a and 230b may connect to a first power source 428a to be provided with voltage V1, while the third and second electrode 430c and 430b may connect a second power source 428b to be provided with voltage V2. The addition of third electrode 230c allows further control of voltage distribution in the liquid crystal layer 222 to provide further fine tuning of the optical properties. Depending on the distribution of the refractive index, the liquid crystal lens module 420b may be a refractive lens or a diffractive lens.

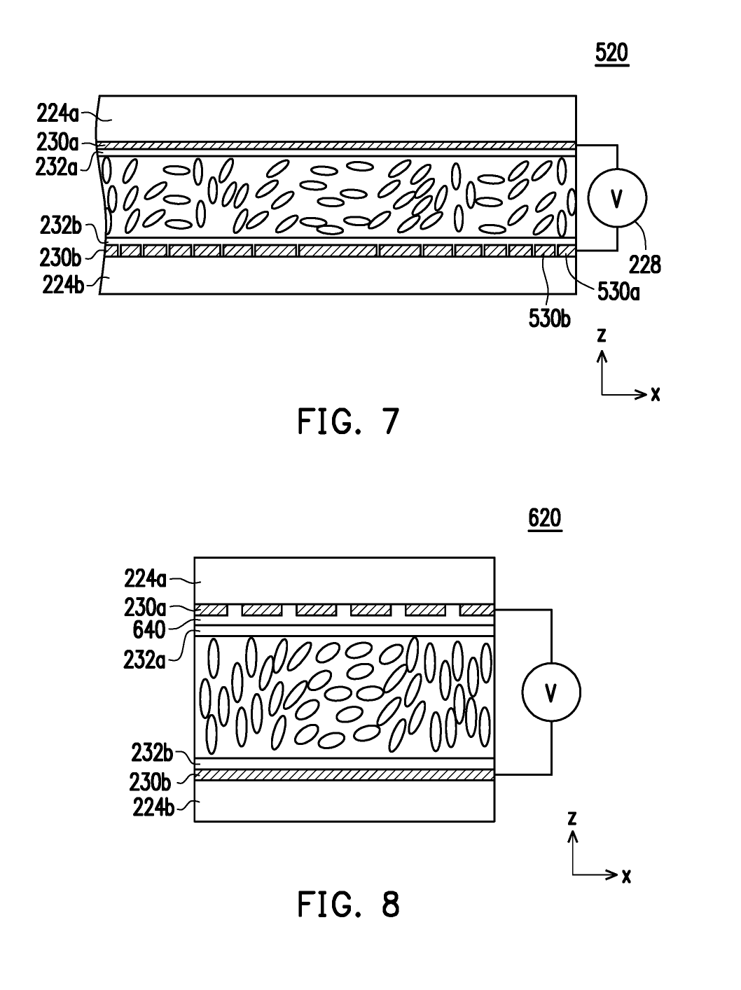

FIG. 7 is a schematic cross-sectional view of liquid crystal lens module 520 according to an embodiment of the invention. Liquid crystal lens module 520 is a liquid crystal lens module with liquid crystal layer 222 having uniform thickness. Specifically, the liquid crystal lens module 520 includes first substrate 224a and second substrate 224b, liquid crystal layer 222, second electrode 230b and alignment layers 232a and 232b that are arranged similarly to liquid crystal lens module 420a. Difference between liquid crystal lens module 520 and liquid crystal lens module 420a lies in the position of first electrode 230a and structure of second electrode 230b. Specifically, in FIG. 7, the first electrode 230a is disposed between the first substrate 224a and the first alignment layers 232a, and the second electrode 230b is a pixilated electrode. The second electrode 230b includes at least one electrode 530a connected to a power source 228 and at least one floating electrode 530b disposed adjacent to the electrode 530a to fonn the pixilated structure. The floating electrodes 530b are separated by insulators disposed therebetween, such as being separated by part of the first alignment layers 232b as shown in FIG. 7. In some embodiments, floating electrodes 530b can also be disposed on the first substrate 230a, the second substrate 230b, or both the first substrate 230a and the second substrate 230b. The voltages across floating electrodes 530b of second electrode 230b are related to the adjacent electrode 530a. Floating electrodes 530b provides more steps of voltage change to better control orientation of liquid crystal molecules in the liquid crystal layer 222. Alternatively, some or all of the floating electrodes 530b may also be individually connected to other power sources to further control the liquid crystal molecules. Depending on the distribution of the refractive index, the liquid crystal lens module 520 may be a refractive lens or a diffractive lens.

FIG. 8 is a schematic cross-sectional view of liquid crystal lens module 620 according to an embodiment of the invention. Liquid crystal lens module 620 is similar to liquid crystal lens module 520 except that liquid crystal lens module 620 has pixilated first electrode 230, and further includes a high impedance material layer 640 disposed between the pixilated first electrode 230a and first alignment layers 232a. The high impedance material layer 640 provide continuous varying voltage between the electrodes, therefore improving the quality of the image formed. The sheet resistance of the high impedance material layers 640 ranges from 10⁹ to 10¹⁴ Ω/sq. The high impedance material layers 640 are made of semiconductor material including a III-V semiconductor compound or a II-VI semiconductor compound, or polymer material including PEDOT (poly(3,4-ethylenedioxythiophene)), for example. Of course, the high impedance material layer 640 may be implemented in any of the liquid crystal lens module described above and may have any other pattern. The invention is not limited thereto.

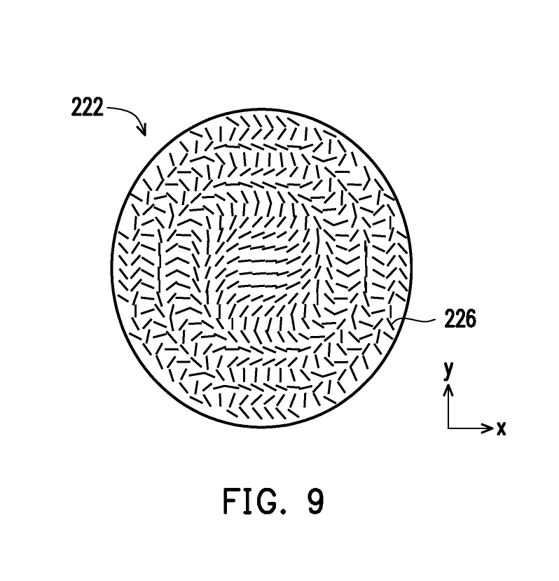

FIG. 9 is a schematic diagram of a liquid crystal layer 222 from a top view, i.e. along z-direction, according to an embodiment of the invention. Specifically, FIG. 9 is an exemplary arrangement pattern of the liquid crystal molecules in the liquid crystal layer 222 in the x-y plane due to alignment layer control. The y-direction provided in FIG. 9 is the direction perpendicular to both x and z direction. In FIG. 9, the polar angle of liquid crystal molecules are controlled by the alignment layer to form the Pancharatnam-Benrry phase liquid crystal lens. Other liquid crystal lens may be formed by having alignment layers with different surface pattern and the invention is not limited thereto.

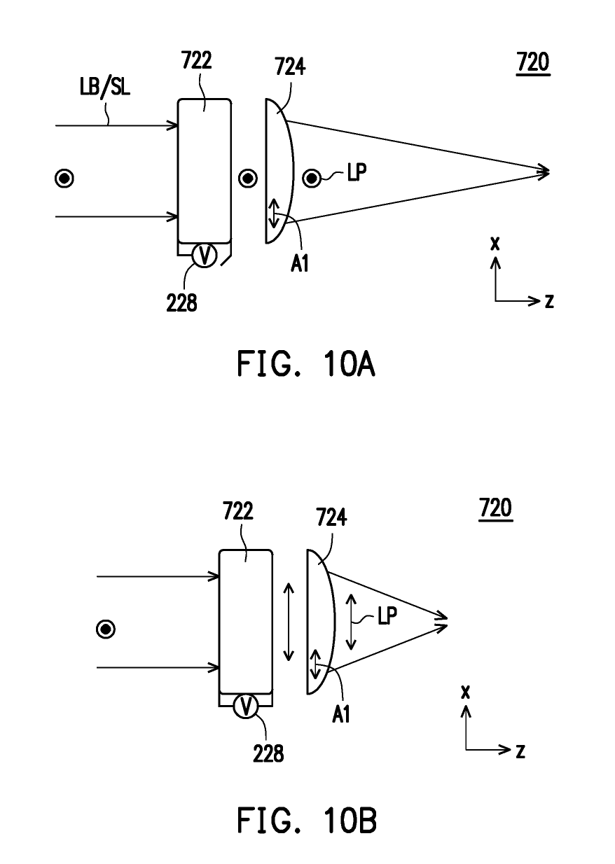

FIGS. 10A and 10B are schematic cross-sectional views of liquid crystal lens module 720 according to an embodiment of the invention. In FIG. 10, the liquid crystal lens module 720 includes a liquid crystal cell 722 and an anisotropic lens 724, wherein the liquid crystal cell 722 is connected to a power source 228. In liquid crystal lens module 720, the liquid crystal cell 722 is disposed on a path of a light polarized in the direction perpendicular to x and z direction. The liquid crystal cell 722 is configured to control the polarization of the incoming light.

Referring to FIGS. 10A and 10B, when the liquid crystal cell 722 is in an off state (voltage not applied), the polarization of incoming light is not affected, when the liquid crystal cell 722 is in an on state (voltage applied), the polarization of incoming light is rotated 90⁰ to be along the x-direction. In other words, when liquid crystal cell 722 is on, liquid crystal cell acts as a half waveplate to change the polarization of incoming light. The anisotropic lens 724 is disposed on the path of light passing through liquid crystal cell 722. The anisotropic lens 724 is a lens which has refractive index (hence focal length) that depends on the polarization of light, for example when light is polarized in optical axis A1 direction of the anisotropic lens, the refractive index is at maximum, when light is polarized orthogonal to optical axis A1 direction, the refractive index is at minimum. Because the on and off state of the liquid crystal cell 722 changes the polarization of light, the focal length of the anisotropic length is also changed. The liquid crystal lens module 720 is also referred to as a passive liquid crystal lens because the liquid crystal cell does not actively converge or diverge the light.

The voltage distribution applied to the electrodes of the liquid crystal lens module, liquid crystal lens cell and to the liquid crystal cell as described above may be controlled by a controller coupled to the electrodes. In some embodiments, the controller is, for example, a central processing unit (CPU), a microprocessor, a digital signal processor (DSP), a programmable controller, a programmable logic device (PLD), or other similar devices, or a combination of the said devices, which are not particularly limited by the invention. Further, in some embodiments, each of the functions of the controller may be implemented as a plurality of program codes. These program codes will be stored in a memory or a non-transitory storage medium, so that these program codes may be executed by the controller. Alternatively, in an embodiment, each of the functions of the controller may be implemented as one or more circuits. The invention is not intended to limit whether each of the functions of the controller is implemented by ways of software or hardware.

By including a liquid crystal lens having variable focal length into a structured light projector, the focusing range of a structured light projector becomes tunable and is able cover a wider range, allowing features of 3D objects at different distances to be measured. Furthermore, when compared to the traditional voice coil motor (VCM) in a focusing lens, the optical projector using liquid crystal lens has the advantage of being more compact and having low power consumption. Hence, the optical projector of the invention may be easily fitted in mobile electronic devices, providing the feature of 3D sensing to mobile electronic devices.

It will be apparent to those skilled in the art that various modifications and variations can be made to the disclosed embodiments without departing from the scope or spirit of the invention. In view of the foregoing, it is intended that the invention covers modifications and variations provided that they fall within the scope of the following claims and their equivalents.

What is claimed is:

1. An optical sensing device configured to detect an object or features of the object, the optical sensing device comprising:
a structured light projector configured to project a structured light to the object and comprising:
a light source configured to emit a light beam;
a diffractive optical element disposed on a path of the light beam and configured to generate diffraction patterns so as to form the structured light; and
a liquid crystal lens module disposed on at least one of the path of the light beam and a path of the structured light and capable of controlling between at least two focusing state; and
a sensor, disposed adjacent to the structured light projector, configured to sense a reflected light, wherein the reflected light is reflection of the structured light from the object.

2. The optical sensing device according to claim 1, wherein the liquid crystal lens module comprises
a solid lens disposed on the path of the light beam between the diffractive optical element and the light source; and
a liquid crystal lens cell disposed on the path of the light beam or the path of the structured light.

3. The optical sensing device according to claim 2, wherein the liquid crystal lens cell is disposed between the diffractive optical element and the solid lens.

4. The optical sensing device according to claim 2, wherein the liquid crystal lens cell is disposed between the solid lens and the light source.

5. The optical sensing device according to claim 1, wherein the liquid crystal lens module is a refractive lens or a diffractive lens comprising:
a liquid crystal layer having uniform thickness or non-uniform thickness, wherein orientations of liquid crystal molecules in the liquid crystal layer are tunable; and
a patterned structure disposed on at least one side of the liquid crystal layer.

6. The optical sensing device according to claim 5, wherein the patterned structure comprises patterned electrodes disposed on at least one side of the liquid crystal layer to control voltage distribution in the liquid crystal layer, wherein the patterned electrodes are hole patterned electrodes, curved electrodes or pixilated electrodes.

7. The optical sensing device according to claim 6, wherein the liquid crystal lens module further comprise high impedance material layers disposed adjacent to the patterned electrodes to provide a continuous variation of voltage distribution in the liquid crystal layer.

8. The optical sensing device according to claim 5, wherein an alignment layer is formed in the liquid crystal layer to control a pretilt angle or a polar angle of the liquid crystal molecules in the liquid crystal layer.

9. The optical sensing device according to claim 1, wherein the liquid crystal lens module is a passive liquid crystal lens comprising:
a liquid crystal cell configured to control the polarization of the light beam or the structured light passing through, and
an anisotropic lens, configured to focus the light beam or the structured light passing through the liquid crystal cell, wherein the anisotropic lens has different refractive indexes in two different polarization directions of the light beam or the structured light.

10. A structured light projector comprising:
a light source, configured to emit a light beam;
a diffractive optical element disposed on a path of the light beam and configured to generate diffraction patterns so as to form a structured light; and
a liquid crystal lens module, disposed on at least one of the path of the light beam and a path of the structured light, capable of controlling between at least two focusing state.

11. The structured light projector according to claim 10, wherein the liquid crystal lens module further comprises:
a solid lens disposed on the path of the light beam between the diffractive optical element and the light source, and
a liquid crystal lens cell disposed on the path of the light beam or the path of the structured light.

12. The structured light projector according to claim 11, wherein the liquid crystal lens cell is disposed between the diffractive optical element and the solid lens.

13. The structured light projector according to claim 11, wherein the liquid crystal lens cell is disposed between the solid lens and the light source.

14. The structured light projector according to claim 10, wherein the liquid crystal lens module is a refractive lens or a diffractive lens comprising:
a liquid crystal layer having uniform thickness or non-uniform thickness, wherein orientations of liquid crystal molecules in the liquid crystal layer are tunable; and
a patterned structure disposed on at least one side of the liquid crystal layer.

15. The structured light projector according to claim 14, wherein the patterned structure comprises patterned electrodes disposed on at least one side of the liquid crystal layer to control voltage distribution in the liquid crystal layer, wherein the patterned electrodes are hole patterned electrodes, curved electrodes or pixilated electrodes.

16. The structured light projector according to claim 15, wherein the liquid crystal lens module further comprises high impedance material layers disposed adjacent to the patterned electrodes to provide a continuous variation of voltage distribution in the liquid crystal layer.

17. The structured light projector according to claim 14, wherein an alignment layer is formed in the liquid crystal layer to control a pretilt angle or a polar angle of the liquid crystal molecules in the liquid crystal layer.

18. The structured light projector according to claim 10, wherein the liquid crystal lens module is a passive liquid crystal lens comprising:
a liquid crystal cell configured to control the polarization of the light beam or the structured light passing through, and
an anisotropic lens, configured to focus the light beam or the structured light passing through the liquid crystal cell, wherein the anisotropic lens has different refractive indexes in two different polarization directions of the light beam or the structured light.
